(19) United States
(12) Patent Application Publication
(10) Pub. No.: US 2005/0015629 A1
(43) Pub. Date: Jan. 20, 2005

(54) Portable non-volatile memory device and data security method of same

(76) Inventor: John C. Wang, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/847,411

(22) Filed: May 17, 2004

(30) Foreign Application Priority Data
Jul. 16, 2003 (TW) 092119462

(51) Int. Cl. H04L 9/32

(52) U.S. Cl. 713/202

(57) ABSTRACT

A portable non-volatile memory device includes a housing, a data access connector, a non-volatile memory, a password-entering interface and a password-verifying device. The data access connector is mounted to the housing and attachable to and detachable from a digital data processor. The non-volatile memory is disposed in the housing and selectively accessible by the digital data processor when the data access connector is attached to the digital data processor. The password-entering interface is disposed in the housing and has a portion exposed from the housing for allowing a user to enter a password. The password-verifying device verifies the password entered via the password-entering device according to a preset pattern, and allows the digital data processor to access to the non-volatile memory when the password complies with the preset pattern.

### FIELD OF THE INVENTION

The present invention relates to a portable non-volatile memory device, and more particularly to a portable non-volatile memory device for use with a digital data processor. The present invention also relates to a data security method of a portable non-volatile memory device.

### BACKGROUND OF THE INVENTION

Referring to FIG. 1, a schematic view of a portable non-volatile memory device is shown. The portable non-volatile memory device 1 is a flash memory device having a USB connector 11 to be connected to a USB bus of a computer. By plugging the portable non-volatile memory device 1 into corresponding slot of the computer, the computer can access data stored in the portable non-volatile memory device 1. One implementation example of such a portable non-volatile memory device is given in U.S. Pat. No. 6,148,354, which is incorporated herein for reference.

A flash memory can be applied to a variety of portable non-volatile memory devices. The commercially available memory devices implemented with flash memories, for example, include Compaq Flash Card (CF), Multi-Media Card (MMC), Memory Stick (MS), Secure Digital (SD), Micro Drive, Smart Media Card (SM), etc. Since these memory cards or sticks are widely used in a variety of portable digital apparatuses such as digital still cameras, they are generally small in size and subject to stealing or loss. Once the portable non-volatile memory device is stolen, the data stored therein become unprotected at all. In other words, any unauthorized user can easily access to the data in the memory device.

For the purpose of data security, a personal identification number (PIN) is required to verify the qualified user so as to prevent the stored data from being arbitrarily accessed. Conventionally, the identification pin is preset and entered via the host, e.g. a personal computer or a notebook computer. This data security architecture, however, have some defects for satisfactory protection. For example, if the data access protocol between the host and the portable non-volatile memory device, such as a USB Mass Storage protocol, fails to support the data security architecture, or if the operating system of the host fails to implement an appropriate security protocol, an increased number of access points will potentially increase the possibility of an unauthorized user to access the data.

Thus, an alternative data security architecture was developed for user's verification. In this architecture, a biometric detection device such as a fingerprint sensor, is used to verify the exact user, as is described in U.S. Pat. No. 6,539,380, which is incorporated herein for reference. Such a solution, although advanced, is not currently feasible due to the high cost. In addition, the qualified user is too limited to normally use the memory device.

### SUMMARY OF THE INVENTION

The present invention provides a portable non-volatile memory device and a data security method capable of implementing data security with high reliability and low cost.

In accordance with a first aspect of the present invention, there is provided a portable non-volatile memory device. The portable non-volatile memory device comprises a housing, a data access connector, a non-volatile memory, a password-entering interface and a password-verifying device. The data access connector is mounted to the housing and attachable to and detachable from a digital data processor. The non-volatile memory is disposed in the housing and selectively accessible by the digital data processor when the data access connector is attached to the digital data processor. The password-entering interface is disposed in the housing and has a portion exposed from the housing for allowing a user to enter a password. The password-verifying device verifies the password entered via the password-entering device according to a preset pattern, and allows the digital data processor to access to the non-volatile memory when the password complies with the preset pattern.

For example, the data access connector is attached to the digital data processor by being plugged into a data access socket of the digital data processor.

For example, the data access connector is a USB connector and the data access socket is a USB bus socket.

For example, the data access connector is a memory card contact electrode and the data access socket is a memory card socket.

In an embodiment, the password-entering device comprises a button set disposed on the housing to be selectively pushed by a user to enter the password.

In an embodiment, the password-entering device comprises at least one rotary disc disposed on the housing to be selectively turned by a user to enter the password.

In an embodiment, the password-entering device further comprises a resetting interface disposed on the housing for resetting the preset pattern.

In an embodiment, the password-verifying device comprises a data bus connection interface, a non-volatile memory connection interface, a password-entering device connection interface and a control unit. The data bus connection interface is electrically connected to the data access connector. The non-volatile memory connection interface is electrically connected to the non-volatile memory. The password-entering device connection interface is electrically connected to the password-entering device for receiving the password. The control unit is interconnected among the data bus connection interface, the non-volatile memory connection interface and the password-entering device connection interface. The control unit is used for determining whether the password complies with the preset pattern or not, and asserting a memory-identifying signal to the digital data processor when the password complies with the preset pattern.

In an embodiment, the control unit asserts a non-memory identifying signal to the digital data processor when no password is entered or the password entered via the password-entering device does not comply with the preset pattern.

In an embodiment, the control unit asserts a partial-memory identifying signal to the digital data processor when no password is entered or the password entered via the password-entering device does not comply with the preset pattern.

In an embodiment, the portable non-volatile memory device further comprises a status indicator for indicating the successful access to the portable non-volatile memory device.

For example, the non-volatile memory is a flash memory.

In accordance with a second aspect of the present invention, there is provided a password-verifying device for use in a portable non-volatile memory device. The portable non-volatile memory device comprises a non-volatile memory, a data access connector via which a digital data processor is selectively allowed to access to the non-volatile memory, and a password-entering device for entering a password to successfully access to the non-volatile memory. The password-verifying device comprises a data bus connection interface, a non-volatile memory connection interface, a password-entering device connection interface and a control unit. The data bus connection interface is electrically connected to the data access connector. The non-volatile memory connection interface is electrically connected to the non-volatile memory. The password-entering device connection interface is electrically connected to the password-entering device for receiving the password. The control unit is interconnected among the data bus connection interface, the non-volatile memory connection interface and the password-entering device connection interface for determining whether the password complies with a preset pattern or not, and asserting a memory-identifying signal to the digital data processor when the password complies with the preset pattern.

In an embodiment, the control unit comprises a program memory storing therein a plurality of instructions for executing the following steps. Firstly, a first signal is asserted to a data bus of the digital data processor via the data bus connection interface to have the portable non-volatile memory device identified as a non-memory peripheral device by the digital data processor. Then, the password received via the password-entering device connection interface is compared with the preset pattern. Afterward, a second signal in lieu of the first signal is asserted to the data bus of the digital data processor via the data bus connection interface to have the portable non-volatile memory device correctly identified by the digital data processor when the password complies with the preset pattern.

In an embodiment, the portable non-volatile memory device comprises a first memory portion and a second memory portion. The control unit comprises a program memory storing therein a plurality of instructions for executing the following steps. Firstly, a first signal is asserted to a data bus of the digital data processor via the data bus connection interface to have only the first portion of the portable non-volatile memory device correctly identified by the digital data processor. Then, the password received from the password-entering device connection interface is compared with the preset pattern. Afterward, a second signal is asserted to the data bus of the digital data processor via the data bus connection interface to have the second portion of the portable non-volatile memory device correctly identified by the digital data processor when the password complies with the preset pattern.

In accordance with a third aspect of the present invention, there is provided a data security method for use with a portable non-volatile memory device and a digital data processor. The portable non-volatile memory device comprising a password-entering device. Firstly, a password is entered via the password-entering device after the portable non-volatile memory device is made in communication with the digital data processor. Then, it is determined whether the password complies with a preset pattern. Afterward, a disguising signal is asserted to prevent the digital data processor from accessing data from at least a designated portion of the portable non-volatile memory device when the password does not comply with the preset pattern.

In an embodiment, the disguising signal is a non-memory identifying signal for indicating the portable non-volatile memory device as a non-memory peripheral device so that the digital data processor will not access to any portion of the portable non-volatile memory device.

In an embodiment, the disguising signal is a partial-memory identifying signal for indicating the portable non-volatile memory device excluding the designated portion as a memory device so that the digital data processor can access to the portable non-volatile memory device except the designated portion.

In an embodiment, the data securing method further comprises steps of switching the portable non-volatile memory device to a password-setting state, entering a new password in the password-setting state to modify the preset pattern, and storing the modified preset pattern.

In an embodiment, the password-setting state of the portable non-volatile memory device is entered and the modified preset pattern is stored by respectively continuously triggering a resetting interface for a certain period of time.

In an embodiment, the password-setting state is prohibited when at least the designated portion of the portable non-volatile memory device is disallowed to be accessed to.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram showing the appearance of a conventional portable non-volatile memory device;

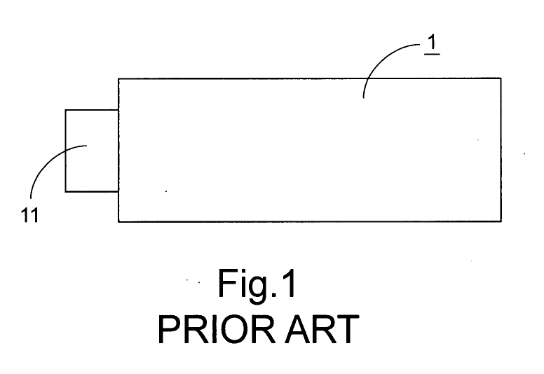

FIG. 2(a) is a schematic diagram showing the appearance of a portable non-volatile memory device according to a preferred embodiment of the present invention;

FIG. 2(b) is a functional block diagram for implementing the portable non-volatile memory device in FIG. 2(a);

FIG. 2(c) is a circuit block diagram for implementing a password-verifying device of FIG. 2(b);

FIG. 3 is a flowchart illustrating an exemplified process for changing the password for accessing to the portable non-volatile memory device according to the present invention; and

FIG. 4 is a schematic diagram showing the appearance of a portable non-volatile memory device according to another preferred embodiment of the present invention.

### DETAILED DESCRIPTION OF THE PREFERRED EMBODIMENT

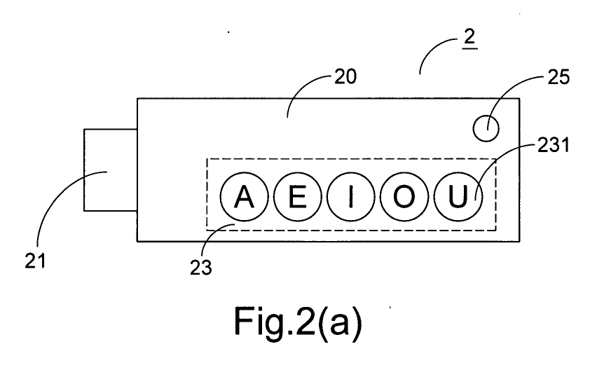

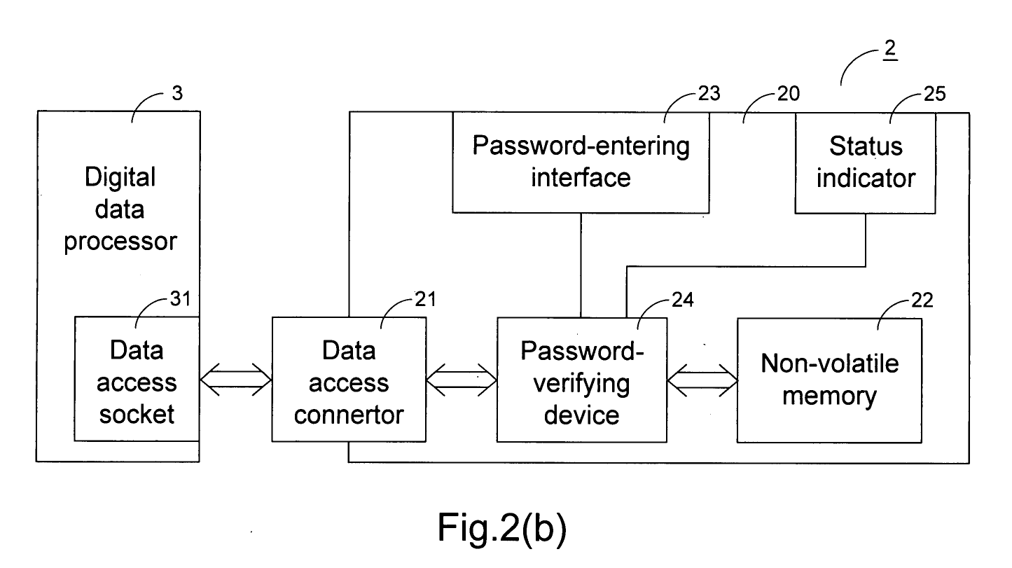

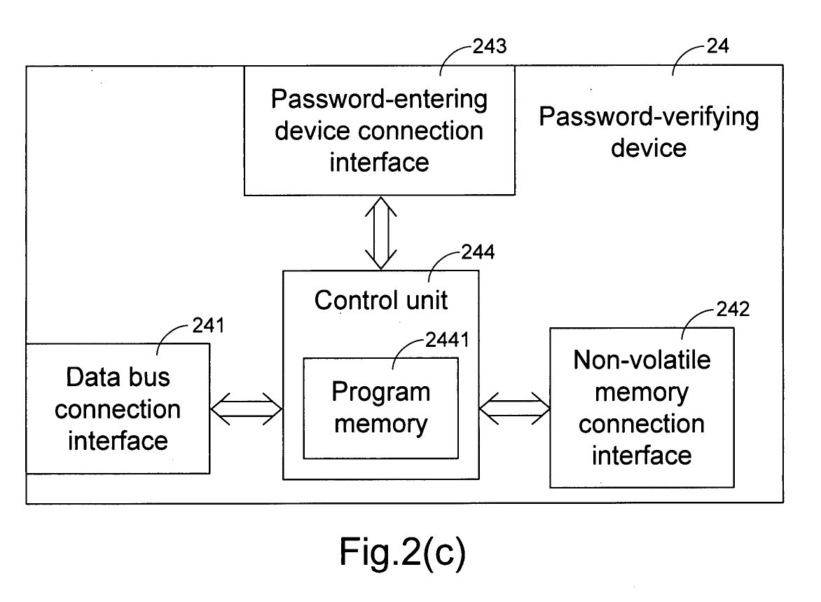

Please refer to FIGS. 2(a) and 2(b), which illustrate the appearance and functional blocks of a portable non-volatile memory device 2 according to an embodiment of the present invention, respectively. The portable non-volatile memory device 2 comprises a data access connector 21, a non-volatile memory 22, a password-entering interface 23, a password-verifying device 24 and a status indicator 25, all integrated with a housing 20.

The data access connector 21 is mounted to the housing 20 and attachable to and detachable from a digital data processor 3 such as a personal computer. When the data access connector 21 is plugged into a data access socket 31 of the digital data processor 3, the portable non-volatile memory device 2 is made in communication with the digital data processor 3 for data exchange therebetween. Of course, the data access connector 21 and the data access socket 31 should match with each other. For example, for the portable non-volatile memory device being a USB storage device, the data access connector 21 and the data access socket 31 are a USB connector and a USB bus socket, respectively.

The non-volatile memory 22, e.g. a flash memory, is disposed in the housing 20. If a correct password is entered after the data access connector 21 is plugged into the data access socket 31 of the digital data processor 3, the non-volatile memory 22 becomes accessible by the digital data processor 3.

The entering of a password is implemented with a password-entering interface 23, which is disposed in the housing 20 and has a portion exposed from the housing for allowing a user to enter a password. In this embodiment, the password-entering device comprises a button set having a series of buttons 231 disposed on the housing 20. The series of buttons are preferably differentially labeled, e.g. letters A, E, I, O and U as shown, for purpose of distinction and memorization. The user is required to selectively push the buttons to enter a password if he would like to access to the non-volatile memory 22.

The password entered via the password-entering interface 23 has to be verified by the password-verifying device 24 in order to successfully access to the non-volatile memory 22. The password entered via the password-entering device 23 is verified by the password-verifying device 24 according to a preset pattern, which has been previously recorded in the non-volatile memory 22 or a memory in the password-verifying device 24. The digital data processor 3 is allowed to access to the non-volatile memory 22 when the password complies with the preset pattern, i.e. the password is verified to be correct. Meanwhile, the status indicator 25 asserts a notifying signal to indicate the successful access to the non-volatile memory 22. For example, the status indicator 25 can be a light-emitting diode (LED), which emits light when the non-volatile memory 22 becomes accessible. The detailed circuit configuration of the password-verifying device 24 will be depicted in FIG. 2(c).

As shown in FIG. 2(c), the password-verifying device 24 comprises a data bus connection interface 241, a non-volatile memory connection interface 242, a password-entering device connection interface 243 and a control unit 244, which are integrated in a single chip. The data bus connection interface 241 is electrically connected to the data access connector 21. The non-volatile memory connection interface 242 is electrically connected to the non-volatile memory 22. The password-entering device connection interface 243 is electrically connected to the password-entering device 23 for receiving the password. The control unit 244 is interconnected among the data bus connection interface 241, the non-volatile memory connection interface 242 and the password-entering device connection interface 243 for determining whether the password complies with the preset pattern or not.

In the control unit 244, a program memory 2441 stores therein a plurality of instructions for executing the password-verifying procedure. Before the correct password complying with the preset pattern is entered, a disguising signal is asserted by the control unit 244 to prevent the digital data processor 3 from arbitrarily accessing data from the portable non-volatile memory device 2. For example, if the entire memory 22 is to be protected from being arbitrarily accessed to, a non-memory identifying signal is asserted to a data bus of the digital data processor 3 via the data bus connection interface 241 to have the portable non-volatile memory device 2 identified as a non-memory peripheral device by the digital data processor 3. Consequently, the digital data processor 3 will not intend to access to the non-volatile memory 22. Thereafter, if the user enters a password via the password-entering interface 23, the password received via the password-entering device connection interface 243 is compared with the preset pattern. If the entered password does not comply with the preset pattern, the non-memory identifying signal is continuously asserted to the digital data processor 3. Once the password is determined to comply with the preset pattern by the control unit 244, a memory-identifying signal, in lieu of the non-memory identifying signal, is asserted to the data bus of the digital data processor 3 via the data bus connection interface 241 so as to have the portable non-volatile memory device 2 correctly identified by the digital data processor 3.

Alternatively, the non-volatile memory 22 can be divided into two or more memory portions, and a designated one of the memory portions is not accessible to unless a correct password is entered. For example, a first memory portion of the non-volatile memory 22 is open for arbitrarily accessed to. Whereas, a second memory portion of the non-volatile memory 22 is accessible to only when the password complies with the preset pattern. When no password is entered or the password entered via the password-entering device 23 does not comply with the preset pattern, the control unit 244 asserts a partial-memory identifying signal to the digital data processor 3. In other words, after the data access connector 21 is plugged into a data access socket 31 of the digital data processor 3 (FIG. 2), the first memory portion is correctly identified as a normal data storage device and visible by the digital data processor 3. On the contrary, the second memory portion is either identified as a non-memory device or invisible by the digital data processor 3.

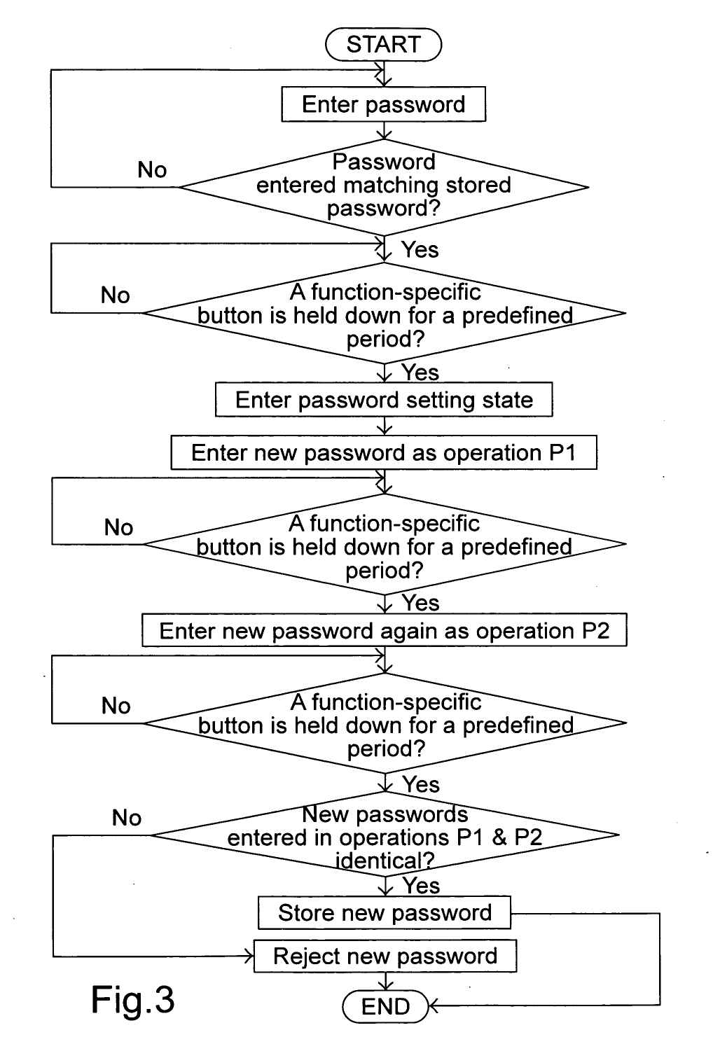

For enhancing security, the security password is preferably changeable as desired. That is, the above-mentioned preset pattern for the entered password to be compared with should be able to be modified. A password-changing procedure according to the present invention will be exemplified hereinafter with reference to a flowchart of FIG. 3. In order to make sure that the password change is executed by a qualified user, the correct security password complying with the original preset pattern is required to be entered first. When the password entered via the password-entering device 23 complies with the original preset pattern, i.e. matching the stored password, the password-changing procedure can go on. By continuously triggering a resetting interface for a defined period of time, for example holding down the function-specific U-button shown in FIG. 2(a) for 3 seconds, the portable non-volatile memory device 2 is switched to a password-setting state. In the password-setting state, a password-entering operation P1 is performed to enter a new password via the password-entering device 23. Next, the function-specific button is held down again for a predefined period to confirm the entering of the new password. Then, a password-econfirmation operation P2 is performed by entering the new password and holding down the function-specific button for a predefined period again. If the passwords entered in the operations P1 and P2 are identical, the new password is stored to replace for the previously stored password. Otherwise, the new password is rejected.

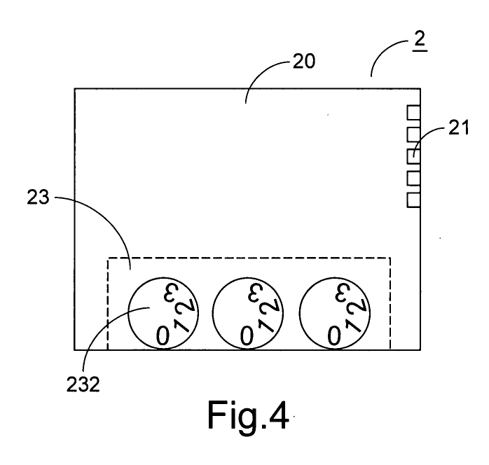

In addition to the use of a button set as the password-entering device 23, any other suitable device can be used herein to enter password therevia. A further embodiment of a portable non-volatile memory device is illustrated in FIG. 4. The portable non-volatile memory device includes the non-volatile memory 22, the password-entering interface 23 and the password-verifying device 24, which are similar to those shown in FIG. 2, and are not to be redundantly described herein. In this embodiment, the portable non-volatile memory device 2 is a memory card, and thus the data access connector 21 and the data access socket 31 are a memory card contact electrode and a memory card socket, respectively. The password-entering device 23 comprises at least one rotary disc 232 disposed on the housing 20, and used for entering password by being selectively turned by a user. The password can also be changed, if necessary, in a manner similar to the flowchart of FIG. 3, by disposing a resetting interface, e.g. an additional button, on the housing 20 to be triggered by the user.

From the above description, it is understood that the data security can be achieved by providing a password-entering device and a password-verifying device to a portable non-volatile memory device. Since the password architecture is disposed on the housing of the portable non-volatile memory device and manipulated in a PIN-entering manner, the user can set or change password easily and reliably to prevent others from arbitrarily accessing to the memory. On the other hand, compared with the data security method implemented with a biometric detection device, the portable non-volatile memory device and the data security method of the present invention are quite low in cost.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A portable non-volatile memory device, comprising:
a housing;
a data access connector mounted to said housing and attachable to and detachable from a digital data processor;
a non-volatile memory disposed in said housing and selectively accessible by said digital data processor when said data access connector is attached to said digital data processor;
a password-entering interface disposed in said housing and having a portion exposed from said housing for allowing a user to enter a password; and
a password-verifing device verifying said password entered via said password-entering device according to a preset pattern, and allowing said digital data processor to access to said non-volatile memory when said password complies with said preset pattern.

2. The portable non-volatile memory device according to claim 1 wherein said data access connector is attached to said digital data processor by being plugged into a data access socket of said digital data processor.

3. The portable non-volatile memory device according to claim 1 wherein said data access connector is a USB connector and said data access socket is a USB bus socket.

4. The portable non-volatile memory device according to claim 1 wherein said data access connector is a memory card contact electrode and said data access socket is a memory card socket.

5. The portable non-volatile memory device according to claim 1 wherein said password-entering device comprises a button set disposed on said housing to be selectively pushed by a user to enter said password.

6. The portable non-volatile memory device according to claim 1 wherein said password-entering device comprises at least one rotary disc disposed on said housing to be selectively turned by a user to enter said password.

7. The portable non-volatile memory device according to claim 1 wherein said password-entering device comprises a resetting interface disposed on said housing for resetting said preset pattern.

8. The portable non-volatile memory device according to claim 1 wherein said password-verifying device comprises:
a data bus connection interface electrically connected to said data access connector;
a non-volatile memory connection interface electrically connected to said non-volatile memory;
a password-entering device connection interface electrically connected to said password-entering device for receiving said password; and
a control unit interconnected among said data bus connection interface, said non-volatile memory connection interface and said password-entering device connection interface for determining whether said password complies with said preset pattern or not, and asserting a memory-identifying signal to said digital data processor when said password complies with said preset pattern.

9. The portable non-volatile memory device according to claim 8 wherein said control unit asserts a non-memory identifying signal to said digital data processor when no password is entered or said password entered via said password-entering device does not comply with said preset pattern.

10. The portable non-volatile memory device according to claim 8 wherein said control unit asserts a partial-memory identifying signal to said digital data processor when no password is entered or said password entered via said password-entering device does not comply with said preset pattern.

11. The portable non-volatile memory device according to claim 1 further comprising a status indicator for indicating the successful access to said portable non-volatile memory device.

12. The portable non-volatile memory device according to claim 1 wherein said non-volatile memory is a flash memory.

13. A password-verifying device for use in a portable non-volatile memory device, said portable non-volatile memory device comprising a non-volatile memory, a data access connector via which a digital data processor is selectively allowed to access to said non-volatile memory, and a password-entering device for entering a password to successfully access to said non-volatile memory, said password-verifying device comprising:
a data bus connection interface electrically connected to said data access connector;
a non-volatile memory connection interface electrically connected to said non-volatile memory;
a password-entering device connection interface electrically connected to said password-entering device for receiving said password; and
a control unit interconnected among said data bus connection interface, said non-volatile memory connection interface and said password-entering device connection interface for determining whether said password complies with a preset pattern or not, and asserting a memory-identifying signal to said digital data processor when said password complies with said preset pattern.

14. The password-verifying device according to claim 13 wherein said control unit comprises a program memory storing therein a plurality of instructions for executing the steps of:
asserting a first signal to a data bus of said digital data processor via said data bus connection interface to have said portable non-volatile memory device identified as a non-memory peripheral device by said digital data processor;
comparing said password received via said password-entering device connection interface with said preset pattern; and
asserting a second signal in lieu of said first signal to said data bus of said digital data processor via said data bus connection interface to have said portable non-volatile memory device correctly identified by said digital data processor when said password complies with said preset pattern.

15. The password-verifying device according to claim 13 wherein said portable non-volatile memory device comprises a first memory portion and a second memory portion, and said control unit comprises a program memory storing therein a plurality of instructions for executing the steps of:
asserting a first signal to a data bus of said digital data processor via said data bus connection interface to have only said first portion of said portable non-volatile memory device correctly identified by said digital data processor;
comparing said password received from said password-entering device connection interface with said preset pattern; and
asserting a second signal to said data bus of said digital data processor via said data bus connection interface to have said second portion of said portable non-volatile memory device correctly identified by said digital data processor when said password complies with said preset pattern.

16. The password-verifying device according to claim 13 being implemented by a single chip.

17. A data security method for use with a portable non-volatile memory device and a digital data processor, said portable non-volatile memory device comprising a password-entering device, said method comprising steps of:
entering a password via said password-entering device after said portable non-volatile memory device is made in communication with said digital data processor;
determining whether said password complies with a preset pattern; and
asserting a disguising signal to prevent said digital data processor from accessing data from at least a designated portion of said portable non-volatile memory device when said password does not comply with said preset pattern.

18. The data securing method according to claim 17 wherein said disguising signal is a non-memory identifying signal for indicating said portable non-volatile memory device as a non-memory peripheral device so that said digital data processor will not access to any portion of said portable non-volatile memory device.

19. The data securing method according to claim 17 wherein said disguising signal is a partial-memory identifying signal for indicating said portable non-volatile memory device excluding said designated portion as a memory device so that said digital data processor can access to said portable non-volatile memory device except said designated portion.

20. The data security method according to claim 17 further comprising steps of:
switching said portable non-volatile memory device to a password-setting state;
entering a new password in said password-setting state to modify said preset pattern; and
storing said modified preset pattern.

21. The data security method according to claim 20 wherein said password-setting state of said portable non-volatile memory device is entered and said modified preset pattern is stored by respectively continuously triggering a resetting interface for a certain period of time.

22. The data security method according to claim 20 wherein said password-setting state is prohibited when at least said designated portion of said portable non-volatile memory device is disallowed to be accessed to.
